(19) United States
(12) Patent Application Publication
(10) Pub. No.: US 2014/0258176 A1
(43) Pub. Date: Sep. 11, 2014

(54) SYSTEM AND METHOD FOR DYNAMIC VISUAL REPRESENTATION OF ESTIMATED FINANCIAL DATA

(71) Applicant: ChartlQ, LLC, (US)

(72) Inventor: Terrence Thorsen, Crozet, VA (US)

(73) Assignee: CHARTIQ, LLC, Crozet, VA (US)

(21) Appl. No.: 13/792,768

(22) Filed: Mar. 11, 2013

(51) Int. Cl. G06Q 40/06

(52) U.S. Cl. CPC G06Q 40/06
USPC 705/36 R

(57) ABSTRACT

A system and method provides for visual analysis of graphical representations of financial data including one or more processing devices operative to perform processing operations including electronically generating a graphical display for a plurality of historical financial data, including the graphical display of values of the financial data over a first time interval. The method and system further includes electronically generating a technical overlay based on the historical financial data and incorporating it within the graphical display. The method and system receives a user input of estimated financial data estimating financial data values over a second time interval, therein updating the technical overlay based on the estimated financial data, including the technical overlay within the second time interval and updating the graphical display including the estimated financial data and the updated technical overlay. The method and system further updates the graphical display with the updated technical overlay.

### RELATED APPLICATIONS

The present application relates to and incorporates herein: copending U.S. patent application Ser. No. ______ entitled “SYSTEM AND METHOD FOR DETECTION AND DISPLAY OF DIVERGENCE WITHIN A FINANCIAL DATA SET” filed Mar. ______, 2013; copending U.S. patent application Ser. No. ______ entitled “SYSTEM AND METHOD FOR FINANCIAL GAP DETECTION” filed Mar. ______, 2013; and copending U.S. patent application Ser. No. ______ entitled “SYSTEM AND METHOD FOR SEQUENTIAL COUNT VISUAL INDICATOR” filed Mar. ______, 2013.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The disclosed technology relates generally to graphical displays of financial information and more specifically to the processing of future price estimations for financial data and the visual representation and display of the historical information, estimated future information and one or more technical indicators applicable to both the historical and estimated future information.

### BACKGROUND

There is a long history of trading stocks, equities or any other financial instruments. Technology has advanced the trading platforms allowing for sellers to sell and buyers to buy these instruments, evolving from early call-out systems to electronic trading platforms to high speed trading systems.

In addition to the buying and selling of instruments, there has also been the growth of price analysis. It is a natural evolution of the trading system for traders to make educated predictions on price fluctuations or movements in these trading instruments. Based on these price estimations, traders can thereby seek to make estimates of when to buy, sell or hold trading instruments. Additional secondary instruments related to underlying financial assets also allow for a greater variety of trading options and hence price movement estimates. By way of example, a trader may take a short position on an equity, thus purchasing or securing options to purchase stocks at a future date.

Prior techniques include intuition or experience for a trader to estimate when and where price movements are to occur. Sophisticated traders additionally developed more scientific stock estimating techniques based on the chart information. Chart information typically includes a two dimensional graph of the instrument priced over a time period. From that graph, traders have developed various techniques to estimate price movements.

On such technique for price estimations includes using physical reproductions of stock charts and manually drawing data points on the chart. From these data points, a trader can attempt to discern one or more patterns for the price movement of the instrument and then make price estimations.

With the computerization of trading platforms and financial instrument price data, current computer systems are also equipped to electronically calculate the various historical price movement data. For example, one type of price data may be a daily moving average for a stock, indicating the average price for the stock over a trading period. Computing systems can then readily generate the historical price average and display that on a two dimensional graph. This is a common stock display as visible when accessing stock price information from any number of stock price sources, including the option to adjust the time period, such as for example from months to days to hours to minutes, etc. From this information, the trader can then make an estimation of the price movement and then execute or delay a trade or other transaction.

Current systems allow for the overlay of technical indicators, also known as studies. For example, one chart may include candlestick displays for a stock over a period of time, wherein the computing system then provides an overlay of a moving average over the same period of time. In the existing systems, the user can then be presented with a graphical display of nothing but historical data and the analysis of the historical data.

Current systems can display historical data or backdate trading estimations or theories, also known as backtesting. In this case, a trader may test or model a trading strategy against the historical data. This technique is fundamentally limited to being only backwards looking to vet a trading model, but has no application for future price estimates. In other words, current charting systems, at best, are limited to working with historical only data and fail to provide any direct computation or feedback relating to future estimated trading data.

Current financial instrument tracking and graphing systems are relegated to historical only data. Users are unable to accurately apply the graphical interface to predictive financial data and the graphical tools cannot be used to visualize or provide visual feedback for estimated future price movements or trading models, including providing visual feedback of the technical indicators or studies. Thus, there exists a need for a system and method to provide visual analysis and graphical representation of predicted financial data, including the display of technical indicators applicable to the future estimated financial data.

### BRIEF DESCRIPTION

A system and method provides for visual analysis of graphical representations of financial data. The method and system includes one or more processing devices operative to perform processing operations including electronically generating a graphical display for a plurality of historical financial data, including the graphical display of values of the financial data over a first time interval. The method and system further includes electronically generating a technical overlay based on the historical financial data, the at least one technical overlay representing one or more financial data and incorporating the technical overlay on the graphical display. The method and system further includes receiving, via an input device, a user input of estimated financial data estimating financial data values over a second time interval. The method and system includes updating the at least one technical overlay based on the estimated financial data, including the technical overlay within the second time interval and updating the graphical display including the estimated financial data and the updated technical overlay. Therein, the method and system further includes providing the updated graphical display with the updated technical overlay to a display device.

The method and system includes additional embodiments providing for further aspects of the visual analysis and graphical representation. For example, the method and system may include electronically calculating the technical indicators on the estimated financial data based at least in part on the historical financial data. In another embodiment, the method and system may include receiving additional user input of estimated financial data and generating the updated displays based thereon. For example, the user may enter multiple data points and estimate the change in price values at different time periods.

Moreover, the method and system further includes the dynamic receipt and modifications or adjustments of the technical indicators on the graphical display. Where prior stock analytical tools would allow for the technical indicators to apply only to historical data, those prior techniques failed to supplemental or update the technical indicators, among other shortcomings, for the user-estimated input electronically entered on the graphical display.

### BRIEF DESCRIPTION OF THE DRAWINGS

FIG. 1 illustrates a block diagram of a user processing system providing for visual analysis of graphical representations of financial data including the processing and updating display for estimated financial data;

FIG. 2 illustrates a block diagram of functional block diagrams representing executable operations within the processing system of FIG. 1;

FIG. 3 illustrates a flowchart of the steps of one embodiment of a method for visual analysis of graphical representations of financial data;

FIG. 4 illustrates a screenshot a graphical display with a technical indicator including a user input of estimated financial data;

FIG. 5 illustrates a screenshot of a graphical display with a technical indicator updated reflecting the estimated financial data;

FIG. 6 illustrates a flowchart of one embodiment of the method for visual analysis of graphical representation of financial data including further steps relating to one exemplary technical indicator embodiment; and

FIGS. 7-12 illustrate additional screenshots of various embodiments of the method and system for visual analysis of graphical representation of financial data.

A better understanding of the disclosed technology will be obtained from the following detailed description of the preferred embodiments taken in conjunction with the drawings and the attached claims.

### DETAILED DESCRIPTION

Embodiments of the disclosed technology comprise systems and methods for visual analysis of graphical representations of financial data, including updating and providing technical indicators applicable to estimated future price data.

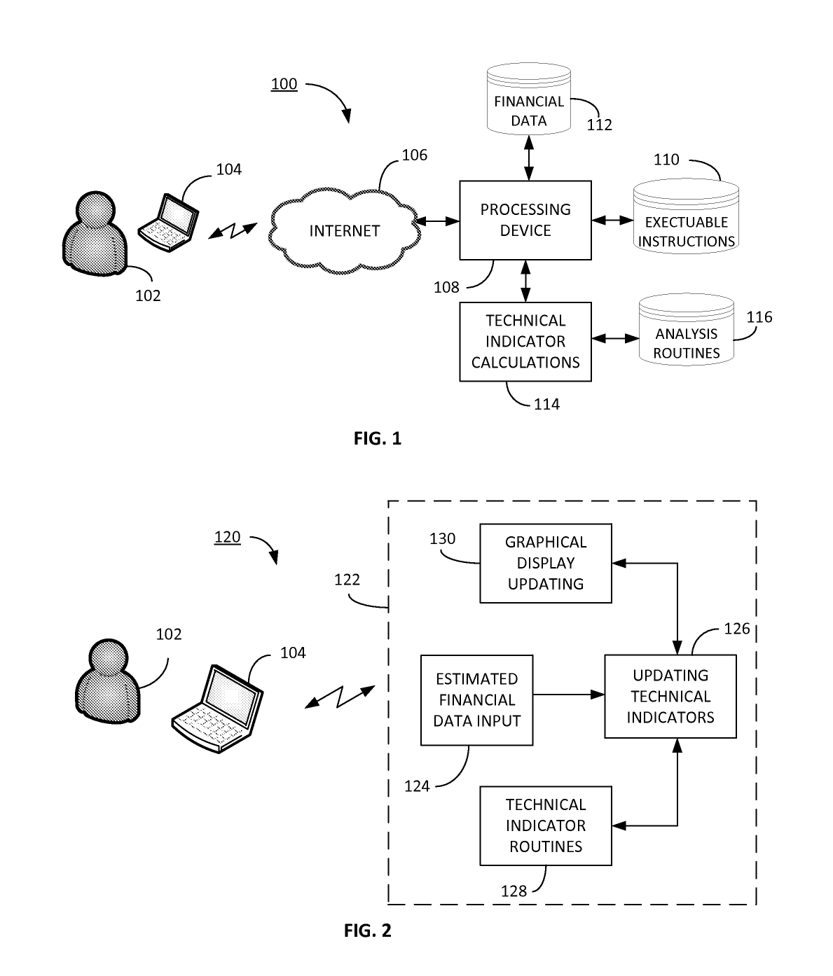

FIG. 1 illustrates one exemplary embodiment of a computing system 100 as described herein. The system 100 includes a user 102, a user computing device 104, a network 106, a processing device 108, executable instructions 110 stored in a memory device, a financial data database 112, a technical indicator calculation engine 114 and a plurality technical indicator analysis routines 116. It is further recognized by one skilled in the art that additional aspects of the system 100 have been omitted for brevity purposes only.

In the system 100, the user 102 may be any user or group of users. For example, the user may be a financial analyst performing computation analysis on a company's stock. In another example, the user may be a trader or broker buying and selling stocks or other equities for clients or for managing one or funds. In yet another example, the user may be an individual performing analysis prior to considering or executing trades themselves. The user may be an expert or professional, as well as be a novice to the management and trading systems.

The user device 104 may be any suitable computing device working in either a stand alone or networked environment. For example, the user device 104 may be a laptop or desktop computer running a browser or other type of application for communicating across the network. In another example, the device 104 may be a smart phone, tablet or other mobile computing device running a browser or application for communication and user input/output. In yet another example, the device 104 can be a dedicated terminal for stock and equity management activities. In one embodiment, the device 104 interfaces across the network 106, whereby processing operations are performed on the network side, in a software-as-a-service manner. In another embodiment, processing operations described below on the network side may also be disposed within the user device 104 or distributed between the network and the device 104.

The network 106 is most generally referred to as the Internet. This network 106 may be any suitable type of network, including but not limited to a local area network, wide area network, virtual private network, among others. In general terms, the network 106 provides for data communication thereacross, including any suitable protocol transmissions and security measures as recognized by one skilled in the art. The network 106 provides the medium for data communication between the device 104 and the processing device 108.

The processing device 108 may be one or more processing devices operative to perform processing operations in response to executable instructions 110. The processing device 108 may be disposed in one or more servers or other network locations, not expressly designated in FIG. 1. The processing operations may be performed in a unitary processing system or in another embodiment may be distributed across one or more processing systems. Whereby, the processing device is operative to perform processing operations described herein such that the user 102 receives a graphical display of the visual analysis of financial data including analysis of estimated future data.

The executable instructions 110 may be software code or other types of instructions readable by the processing device 108, stored in one or more computer readable medium, such as non-transitory medium, including for example one or more data storage devices. The data storage devices may be centrally located or can be accessible in a distributed environment, as recognized by one skilled in the art.

The financial data 112 includes historical data relating to financial instruments. As used herein, financial instruments can be any type of stock, equity, fund, fund of funds, or other tradable or exchangeable element having a value affixed thereto. The financial data 112 may be assembled within the system 100 or in another embodiment the data 112 is provided via one or more source providers. For example, the system 100 may include financial data information feeds from market sources providing timely financial data. Thus, the database 112 of FIG. 1 can be illustrative of the data, but it is recognized that in one embodiment, the financial data is provided via one or more data feeds.

The technical indicator calculation engine 114 may be one or more processing devices performing technical indicator calculations. In one embodiment, the engine 114 may be embedded within the processing device 108, but is illustrated separate therefrom in the system 100 for illustration purposes.

Moreover, the engine 114 may be disposed in a processing system separate from the processing device 108, such as via a networked connection. For example, a third party provider may provide a technical indicator operation, such that the processing device 108 networks out to the engine 114 for the performance of one or more technical indicator operations. In another example, technical indicator operations may be readily encapsulated within the stock analysis and graphical viewing system, whereby the technical indicator operations are locally performed relative to the processing device 108 for real time processing.

As described further herein, there are numerous possible technical indicator operations. For illustration purposes, FIG. 1 illustrates the database 116 storing the various analysis routines executable by the engine 114. Various operations therein can be updated, modified or otherwise adjusted based on the adjustment of the routines in the database 116, as well as the integration of additional routines by inclusion of execution operations of the additional routines in the engine 114.

Various technical indicators may be utilized. Below represents a sample listing of technical indicators and is not an exclusive or exhaustive list of routines available or usable with the system 100 of FIG. 1. Processing routines of these indicators are generally known to those skilled in the art and hence the algorithmic operations of each technical indicators are omitted for brevity purposes only. Technical indicator operations and processing routines may include: Moving Average; 9/13 Count; Welles Wilder Smoothing; Williams % R; Williams Accumulation Distribution; Volume Oscillator; Vertical Horizontal Filter; Ultimate Oscillator; True Range; Average True Range; Rainbow Oscillator; Price Oscillator; Parabolic SAR; Momentum Oscillator; MACD; Ease of Movement; Directional Movement System; Detrended Price Oscillator; Chande Momentum Oscillator; Chaikin Volatility; Aroon; Aroon Oscillator; Linear Regression R2; Linear Regression Forecast; Linear Regression Slope; Linear Regression Intercept; Price Volume Trend; Performance Index; Commodity Channel Index; Chaikin Money Flow; Weighted Close; Volume Rate of Change; Typical Price; Standard Deviation; Price Rate of Change; Median Price; High Minus Low; Bollinger Bands; Fractal Chaos Bands; High Low Bands; Moving Average Envelope; Swing Index; Accumulative Swing Index; Comparative Relative Strength; Mass Index; Money Flow Index; Negative Volume Index; On Balance Volume; Positive Volume Index; Relative Strength Index; Trade Volume Index; Stochastic Oscillator; Stochastic Momentum Index; Fractal Chaos Oscillator; Prime Number Oscillator; Prime Number Bands; Historical Volatility; MACD Histogram; Highest High Value; Lowest Low Value; Time Series Forecast; TRIX; Elder Ray; Elder Force Index; Elder Thermometer; Ehler Fisher Transform; Keltner Channel; Market Facilitation Index; Schaff Trend Cycle; QStick; Stoller Average Range Channel; Center Of Gravity; Coppock Curve; Chande Forecast Oscillator; Gopalakrishnan Range Index; Intraday Momentum Index; Klinger Volume Oscillator; Pretty Good Oscillator; RAVI; Random Walk Index; and Twiggs Money Flow

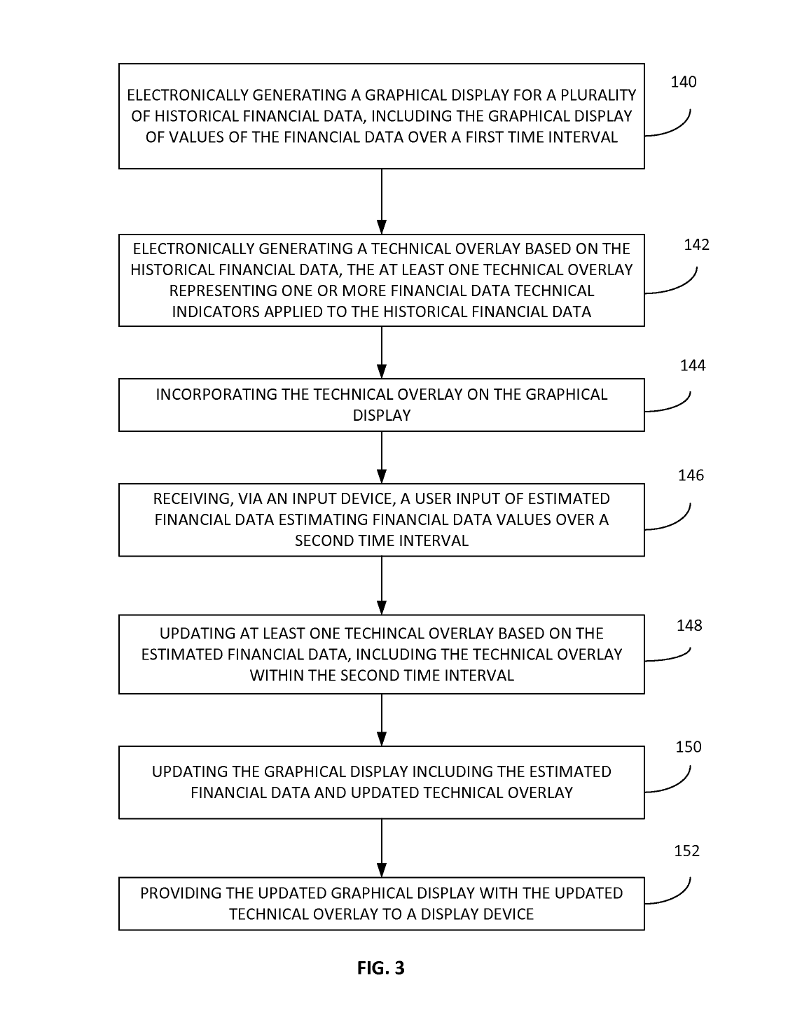

For the sake of brevity, operations of the system 100 are described in further detail below, including with respect to the flowchart of FIG. 3.

FIG. 2 illustrates a block diagram of system 120 illustrates of engine components operative within the system 100. The system 120 includes the user 102 and user device 104 in operative communication with the processor(s) 122. The processor(s) 122 includes numerous processing routines operative to provide the visual analysis of graphical representations described herein. The routines include an engine 124 for receiving an estimated financial data input, an engine for updating the technical indicators 126, an engine 128 including the technical indicator routines 128 and an engine 130 for updating the graphical display.

The engines 124-130 are executable on one or more processing devices in a central or distributed processing environment. For example, the engines 124-130 may be disposed exclusively within the processing device 108 of FIG. 1, or distributed between the engine 114 and one or more devices 108. Similar to the system 100 of FIG. 1, the operations of the various engines 124-130 are described in further detail below relative to the flowchart of FIG. 3

FIG. 3 illustrates the steps of one embodiment of a method for visual analysis of graphical representations of financial data. The methodology is executable by one or more processors performing processing operations in response to executable instructions. Step 140, is generating a graphical display for a plurality of historical financial data, including the graphical display of values of the financial data over a first time interval.

With reference to FIG. 1, the processing device 108 retrieves the financial data 112 from one or more sources and generates the graphical display over a particular time period. The graphical representation of the financial data is consistent with existing graphical techniques whereby in one embodiment time is noted on the x-axis and the price or value of the equity is noted on the y-axis. The graphical representation generated in step 140 is the baseline graphic of value over time information for a selected equity.

Various embodiments include further steps prior to the graphical representation, not expressly illustrated. For example, a prior step may include the user 102 of FIG. 1 selecting a particular equity from a list of available equities. It is noted that as used herein, equity is a general term to represent any item or element having a particular value or cost associated therewith, including but not limited to stocks, bonds, funds, metals, resources, etc.

Thus, via a graphical user interface, the user 102 can search or select for a particular equity and a corresponding graphical display is generated showing price or value of the equity over a period of time. The user may also adjust the time period from a default period, such as the period being in months, days, hours, minutes, etc.

In the flowchart of FIG. 3, step 142 electronically generates a technical overlay based on the historical financial data, the at least one technical overlay representing one or more financial data technical indicators applied to the historical financial data. With respect to FIG. 1, the technical indicator calculation engine 114 using the analysis routines 116 generates the technical indicators. In one embodiment, the user 102 may select one or more technical indicators. As described in further detail below, there are many number of different technical indicators or studies applicable to the financial data. Based on the user selection, the system 100 of FIG. 1 therein generates the technical overlay by performing the technical analysis on the historical financial data.

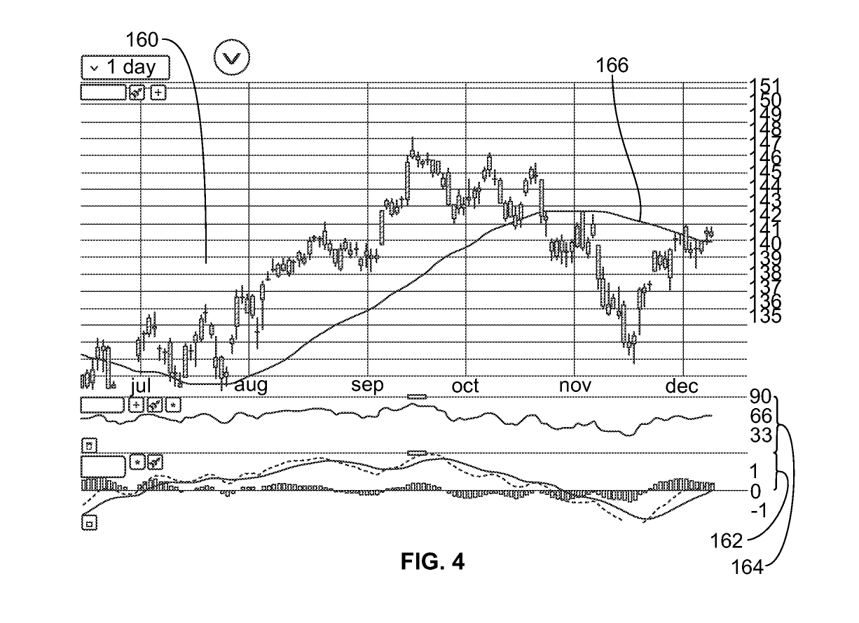

In step 144 of FIG. 3, the processing device 108 therein incorporates the technical overlay on the graphical display. FIG. 4 illustrates a screenshot of a graphical display including the financial data and the technical overlays. The graphic illustrates the stock price during the first time period. The technical overlays can be provided adjacent to the financial data such as sharing a common x-axis with the financial data. The technical overlays can also be inscribed on the existing graph, directly over the financial data.

The screenshot of FIG. 4 illustrates two adjacent overlays and an inscribed overlay. The financial data includes the values of the equity labeled “SPY” illustrating the financial data in a candlestick graphical representation 160. The first technical indicator panel 162 shares the x-axis of time, illustrating a relative strength index (RSI). The second technical indicator panel 164 additionally shares the x-axis, illustrating the moving average convergence-divergence (MACD). The third technical overlay 166 includes the inscribed line, overlaid on the candlestick price data.

With reference back to FIG. 3, in the described embodiment, step 146 receives a user input of estimated financial data estimating financial data values over a second time interval, the user input being received via an input device. For example, with reference to FIG. 1, the user 102 may use a touchpad on the computing device 104 or other type of input device, to estimate the price or value movement of the equity for a second time interval occurring after the first time interval.

In the system 120 of FIG. 2, the estimated financial data input engine receives the input data. In one embodiment, the input may be the user's selection of a particular data point or trajectory for the equity in the second interval. In simplistic terms, the user may estimate the stock price to rise, fall or remain the same during the second time interval.

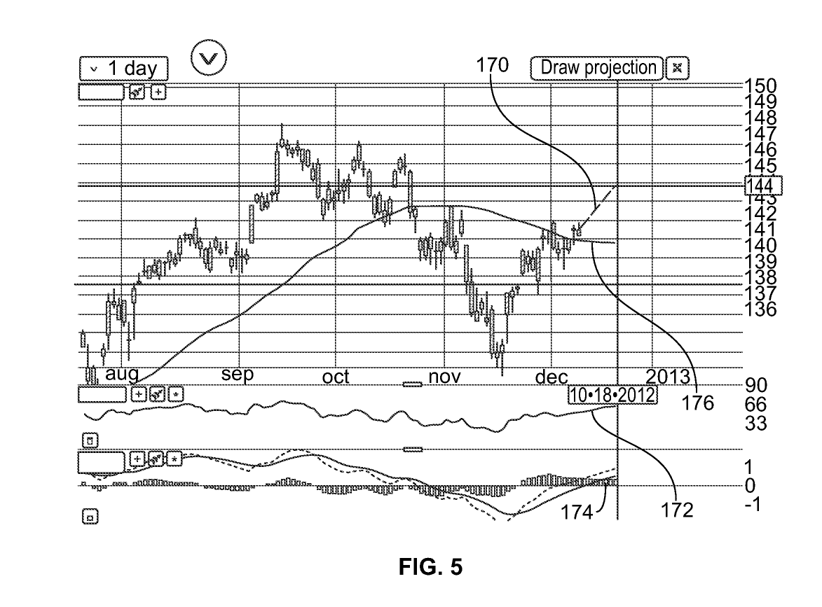

FIG. 5 illustrates a screenshot of the user entering the estimated financial data, in the example being a projection that the equity will increase in value at a future point in time. The screenshot includes the user estimated financial data 170 illustrated as a single straight line connecting the known value data point to the estimated data point. Wherein, the user enters a prediction of estimate future values and such estimated future values are visible and incorporated into the graphical display.

In one embodiment, step 148 updates the at least one technical overlay based on the estimated financial data, including the technical overlay within the second time interval. With respect to FIG. 2, the engine 126 utilizes the technical indicator routines 128 to then process the estimated financial data similar to the processing of the historical financial data. The routine 128 utilizes the estimated data as the new input information, including integrating the estimated data with the historical data, as necessary. The engine 126 then updates the technical indicators by performing the processing routines on the new data set.

With reference back to FIG. 3, step 150 updates the graphical display including the estimated financial data and the updated technical overlay. In the system 122 of FIG. 2, the engine 130 thereby is operative to update the graphical display. The engine 130 receives the updated technical indicator data, including the updated technical data points based on the estimated financial data. The graphical displaying updating unit 130 thereby integrates updated technical information into the graphical information.

In FIG. 3, step 152 provides the updated graphical display with the updated technical overlay to a display device. In one embodiment, the system 122 of FIG. 2 may be integrated in the processing device 108 of FIG. 1, whereby the updated information is then prepared for submission to the user processing device 104 via network 106. The updated display can the visible via a display associated with the user device 104.

For further illustration, FIG. 5 illustrates a screenshot of one embodiment of the updated graphical display. FIG. 5 illustrates an updated display of the screenshot of FIG. 4, including the user's input of estimated financial data 170. This input estimates that the price of the financial instrument will increase in value during the second time period. In this embodiment, the estimated financial data is updated as a straight line extending from the historical price data point to the second time period estimated value data point.

Based on this estimated data value, the screenshot of FIG. 5 illustrates that the system 100 updates the technical overlay data, including the updated second panel technical indicator data 172 during the second time period, the updated third panel technical data 174 and the updated third technical overlay 176, all updated in the second time period.

Therefore, FIG. 3 provides one embodiment of a method for visual analysis of graphical representations of financial data including the ability for a user to apply technical indicators to estimated financial data. Unlike prior techniques that, among other shortcomings, limited the ability to apply technical indicators to historical data, the described method and system of FIGS. 1 and 2 allow for application to estimated data.

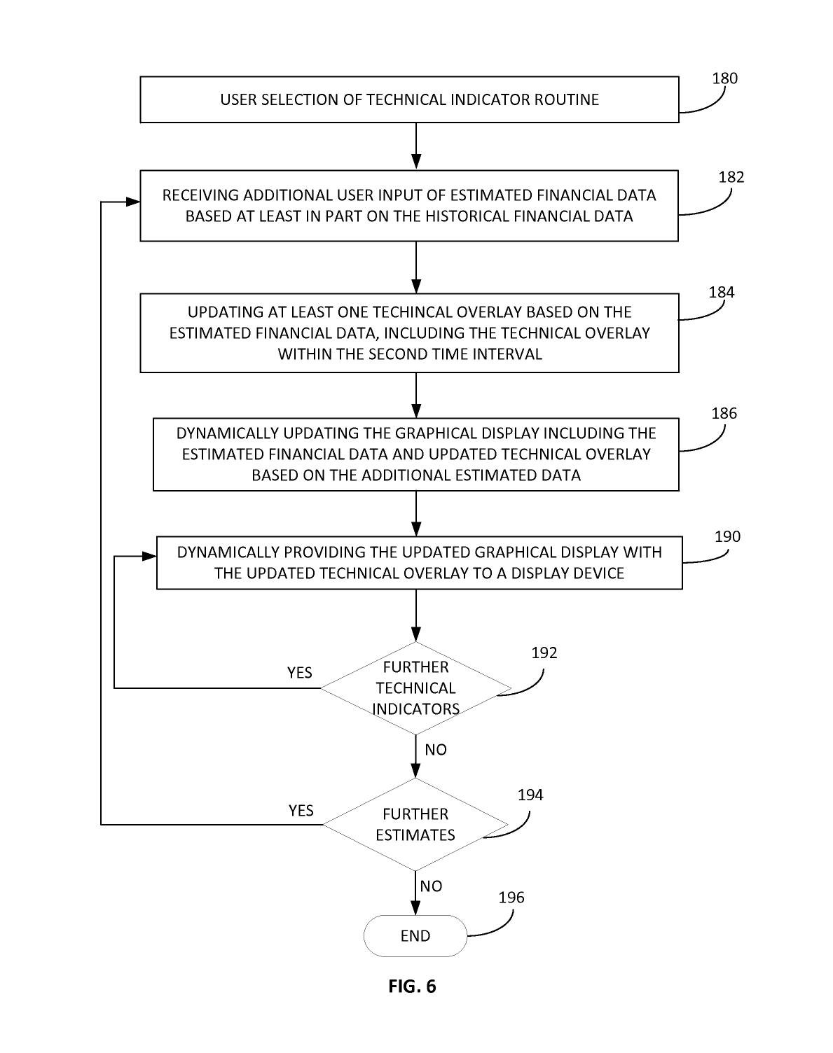

FIG. 6 illustrates another embodiment of the method for visual analysis of predictive financial information. The flowchart of FIG. 6 illustrates various steps operating in addition to one or more steps of FIG. 3, and can be executed via the system 100 of FIG. 1 and/or the processing components of FIG. 2.

In the embodiment of FIG. 6, step 180 is the user selection of a technical indicator routine. As noted herein, there are any number of technical indicator routines. The user can select, such as via the user device 104 of FIG. 1, various technical indicator routines to be applied to the data. Pending on the technical indicator, the indicator may be provided as an overlay directly over the historical data or in secondary display windows sharing a time axis.

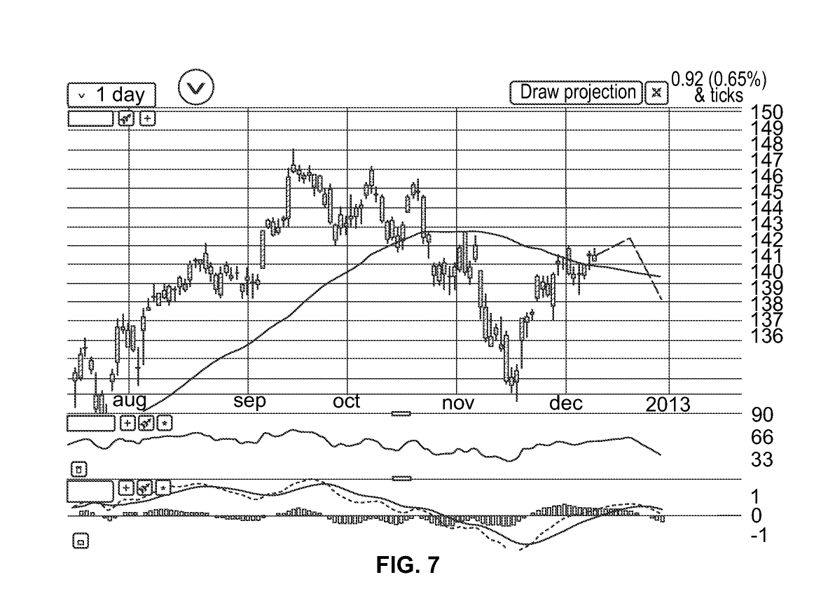

In this embodiment, the user may perform the steps of FIG. 3 for generating a first set of predicted financial data. Therefore, in step 182, the system and method is operative to receive additional user input of estimated financial data based at least in part on the historical financial data. In this embodiment, the user therein selects a second degree of movement of the predicted financial data. FIG. 7 illustrates an exemplary screenshot providing for the user to select the price to rise in the first prediction and then drop in the next prediction. Thus, the predictive line of the price rises in the first time period and falls in the second time period. Similar to the embodiments described above, this adjustable price movement and prediction can be generated based on user input including for example controlling a mouse, keypad, touch screen or other input to select a later-in-time price data point.

In the embodiment of FIG. 6, a next step, step 184, is updating at least one technical overlay based on the estimated financial data, including the technical overlay with the second time interval. Similar to embodiments above, this step may be performed by the processing engines of FIG. 2, taking into account not only the historical data, but also taking into account prior predictive data, e.g. the prior predictive input.

Step 186 dynamically updates the graphical display including the estimated financial data and updated technical overlay based on the additional estimated data. The screenshot of FIG. 7 further illustrates the dynamic updating of the technical indicators with the additional estimated financial data. As visible in the screenshot, the second estimated data falls in value, wherein the technical indicators, in a comparison with the screenshot of FIG. 5, also decrease.

Step 188 dynamically provides the updated graphical display with the updated technical overlay to a display device, similar to step 152 of FIG. 3. Therefore, in this embodiment, the user is presented with a dynamic adjustment of the technical indicator data based on estimated price data. Where prior art techniques failed to calculate technical indicator analysis to future data, one embodiment of the present method and system includes the dynamic adjustment(s) of the predictive data and the dynamic visual display of those adjustments as analyzed by the technical indicator routines.

In the embodiment of FIG. 6, the method includes further iterative operations available to the user. Step 190 includes the step of determining if there are further technical indicators. In one embodiment, the user may select to activate or deactivate various technical indicators. In doing so, the method reverts to dynamically updating the display to include or remove such displays. It is further noted that the system will process the historical financial data and the predictive data through the technical indicator routines to generate the technical overlay provided to the display device 104 in step 188.

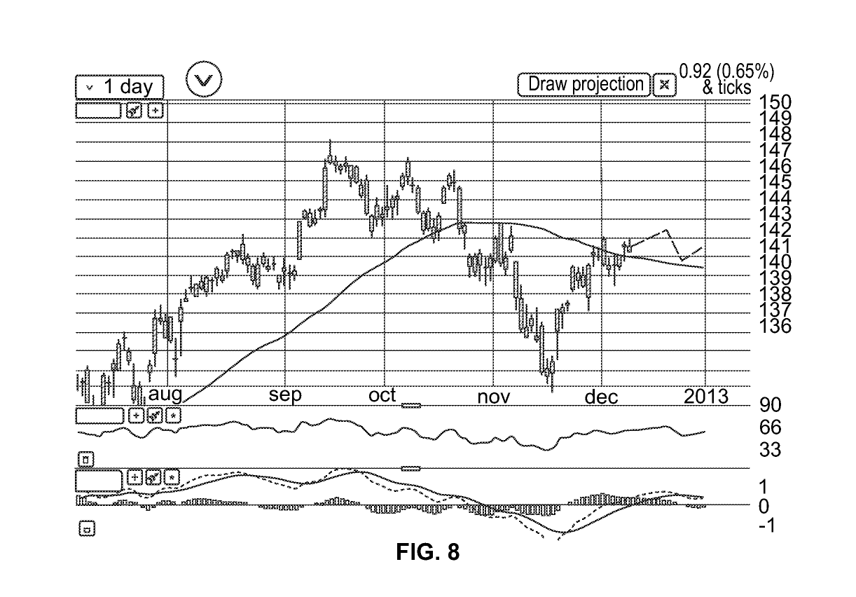

In the event there are no further technical indicators, the method may proceed to step 192 and the inquiry if there are further estimates to be provided by the user. In the event the inquiry 192 is answered in the affirmative, the method reverts back to step 182. The user may then enter additional information and the technical indicators are dynamically adjusted. FIG. 8 illustrates another sample screenshot including the user estimating that the price of financial instrument will rise in a third sequence. The screenshot illustrates that the technical indicators are therefore additionally updated, providing the user with visual feedback for visual analysis of graphical representation of financial data.

Regarding step 192 of FIG. 6, if there are no further technical indicators, the method may proceed to step 194, including the inquiry if there are any further price estimates by the user. If yes, wherein the user wishes to further adjust the price estimation, including adding further time period estimates or even adjusting already submitted predicted data, the method may then revert back to step 182. Via steps 182-190, the processing system therein updates the estimated data, calculates the technical overlay data and provides the visual feedback to the user on the graphical display. In this embodiment, if no further price estimates are requested, the method may conclude, step 196.

It is further noted that the method and system may operate in a processing environment wherein further actual financial data is received during the processing of predicted financial data. For example, one component of the graphical display of the financial data is the adjustment of the time factor, illustrated in the screenshots as being on the x-axis. The time factor can be any suitable time, such as years, quarters, months, weeks, days, minutes, seconds, etc. In a small enough time frame, it reasonable that further actual price data is recorded during the user's predictive analysis.

With reference back to FIG. 1, the financial data 112 may be kept current, therefore one embodiment of the method and system includes account for updated current financial data. The graphical operations provided for generating the original graph, such as the data 160 of FIG. 4, is then additionally applied to the newly received financial data.

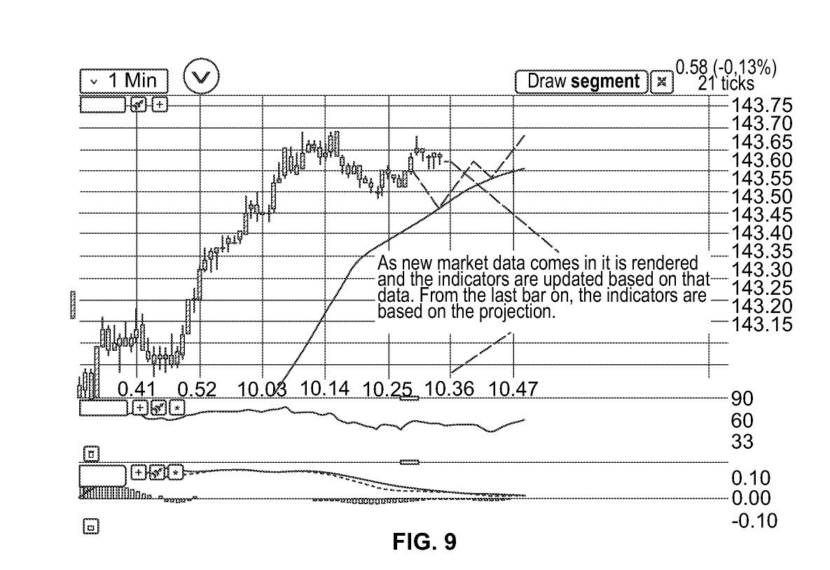

FIG. 9 illustrates a screenshot expanding on the screenshot of FIG. 8. In the screenshot of FIG. 9, the time axis is greatly magnified and the financial data is updated to reflect the known financial data, expanding the data set of the historical financial data. As illustrated in this screenshot, the estimated financial data is still visible, but now visible concurrent with the expanded historical financial data and the continued technical overlay. In this embodiment, the technical indicators are additionally updated to reflect new historical financial data.

Within the method and system, any periodicity of financial data is supported. For projections that are drawn by the user at a given periodicity (say, daily bars where each data point on the graph represents a single day of the equity being traded), those projections are interpolated or extrapolated for other periodicities that might be viewed by the user. This allows the user to, for instance, draw a multi-segment projection on a 30-minute chart, and then if the projection were drawn long enough to span multiple days, zoom out to a daily periodicity as still view the projection. Likewise a projection drawn on a daily chart that extended more than a week, could be viewed when the chart is set to weekly periodicity. This allows the users to see the implication of their projection across multiple trading timeframes.

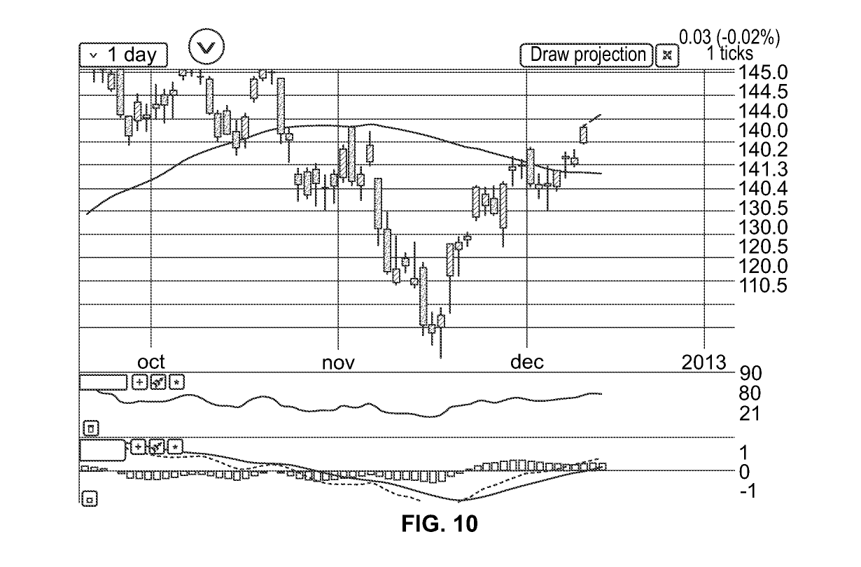

FIGS. 10-12 provide screenshots further illustrating the variable periodicity and the translation of the graphical data consistent with the user-selected periods. In the screenshot of FIG. 10, the user provides an estimate on a daily chart, wherein the x-axis period is per day. The user may then seek to adjust the time periodicity, and the graphical representation remains consistent such that the user's estimated price projection is thus translated into the adjusted time period.

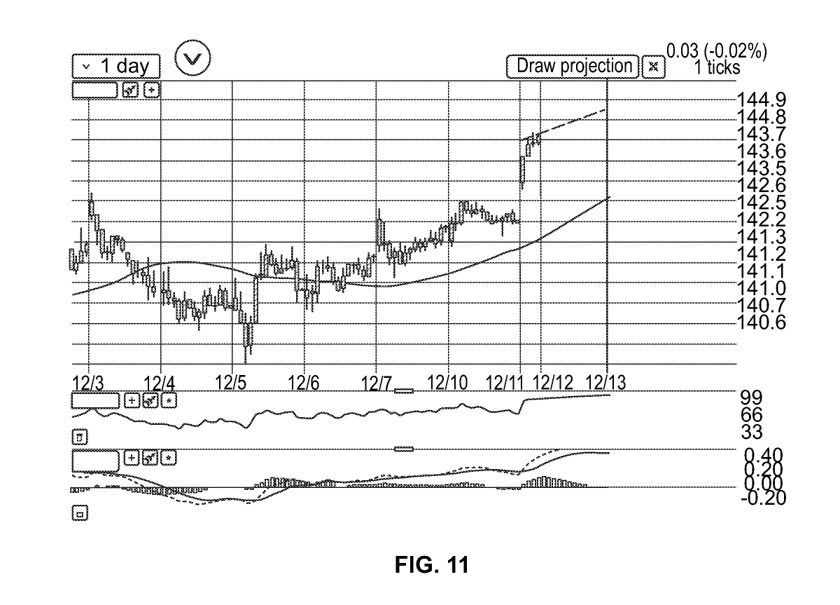

FIG. 11 illustrates a screenshot with the enhanced time period of 30 minute periodicity. The projected estimate remains consistent with the user's original estimate, simply visually represented based on the time period. In the screenshot of FIG. 10, each candlestick represents a day's worth of data and in the screenshot of FIG. 11, the candlestick represents 30 minutes worth of price data.

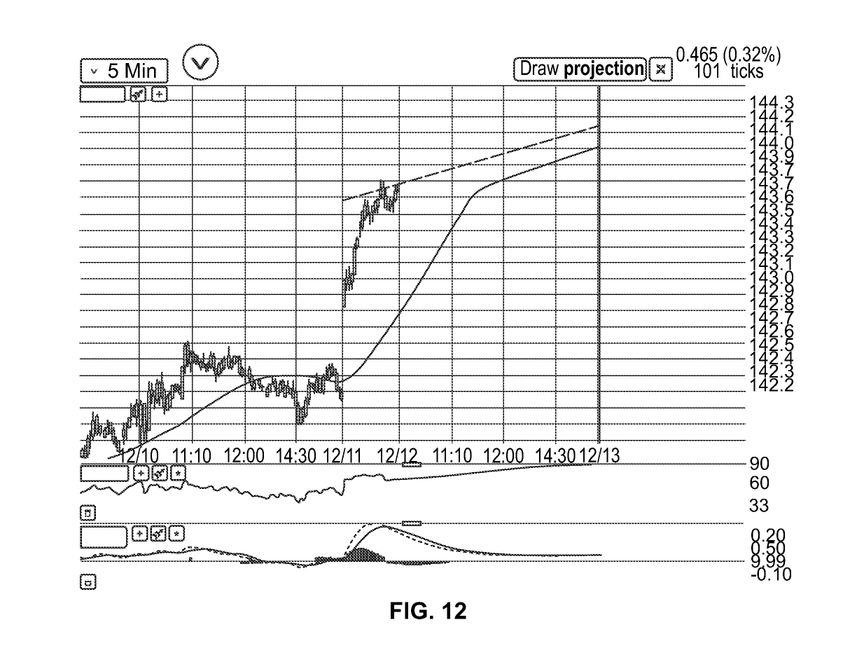

FIG. 12 illustrates a further enhancement of time period, this example being a 5 minute interval. Thus, each candlestick represents the price data over a 5 minute interval and the user's predicted price estimate and the technical overlay at expanded to illustrate the time period adjustment.

Further embodiments of the present method and system are additional within the present scope. For example, in one embodiment, the input of price projections may be performed by manual input of values and time periods or in another embodiment, uploaded from a spreadsheet or other data source. In another embodiment, the processing device 108 may be operative to provide projected price points to be calculated algorithmically, for example using a proprietary formula. The processing device 108 can perform the computational operations to generate these price points.

In another embodiment, the system 100 may include multiple users 102, instead of the unitary user illustrated therein. While each user may perform user-specific price-estimation operations, the system 100 may include the integration or combining of multiple individuals, e.g. crowd. The system can generate an integrated or generalized price estimation from the crowd and therein provide the accompanying technical overlay(s).

In another embodiment, the processing device may include operations for generating intermediate price points when a user enters an end point. While user-generated price estimates provide linear connections between points, fractal or other computational algorithms can be applied to estimate the pricing trajectory from the original price point to the estimated point. This may then generate a zig-zag or other type of movement in the price projections as estimated by the user.

Therefore, the present system and method allows for the graphical display of financial data and the user input of estimated financial data. The graphical display is then updated to illustrate one or more technical indicators applicable to the financial data. Thereby, the user is able to analyze price predictions on financial data and the effect of the technical indicators on the price predictions. The user can adjust the prediction data, receive visual feedback of the technical indicators analyze of the adjusted prediction data. The user is able to add or remove technical indicators and adjust periodicity on the display to better analyze predictive estimations of financial instruments.

FIGS. 1 through 12 are conceptual illustrations allowing for an explanation of the present invention. Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, Applicant does not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein.

1. A method for visual analysis of graphical representations of financial data, the method comprising:
electronically generating, via a processing device a graphical display for a plurality of historical financial data, including the graphical display of values of the financial data over a first time interval, the graphical display for being displayed on a display device;
electronically generating, via the processing device a technical overlay based on the historical financial data, the at least one technical overlay representing one or more financial data technical indicators applied to the historical financial data;
electronically incorporating the technical overlay on the graphical display;
receiving, via an input device, a user input of estimated financial data estimating financial data values over a second time interval;
updating, via the processing device the at least one technical overlay based on the estimated financial data, including the technical overlay within the second time interval;
updating, via the processing device the graphical display including the estimated financial data and the updated technical overlay; and
providing the updated graphical display with the updated technical overlay to the display device.

2. The method of claim 1 further comprising:
electronically calculating the technical indicators on the estimated financial data based at least in part on the historical financial data.

3. The method of claim 1 further comprising:
receiving a second user input of second estimated financial data, the second estimated financial data being based, at least on, the estimated financial data.

4. The method of claim 1 further comprising:
adjusting the estimated financial data in response to the user input device; and
updating the graphical display including the updated technical overlay.

5. The method of claim 4, wherein the dynamically adjusting the estimated financial data includes:
establishing a data point on the graphical display within the second time interval; and
adjusting the estimated financial data beyond the data point.

6. The method of claim 1, wherein the user input of estimated financial data includes estimating at least one of: an increase in value; a decrease in value; and no change in value.

7. The method of claim 1, wherein the graphical display includes a display of the first time interval and the second time interval along an x-axis of the graphical display and the financial values and the estimated financial data along a y-axis of the graphical display.

8. The method of claim 7, wherein the time intervals include at least one of: days, hours, minutes and seconds.

9. The method of claim 1 further comprising:
receiving a periodicity input selection from the user indicating a periodicity of the historical financial data in the first time interval; and
calculating the estimated financial data based on the periodicity input selection.

10. The method of claim 9 further comprising:
receiving a second periodicity input selection for the user adjusting the periodicity of the historical financial data; and
updating the estimated financial data values in the second time interval to be consistent with the second periodicity input.

11. A system for visual analysis of graphical representations of financial data, the system comprising:
a computer readable medium having executable instructions stored therein; and
a processing device, in response to the executable instructions, operative to:
electronically generate a graphical display for a plurality of historical financial data, including the graphical display of values of the financial data over a first time interval;
electronically generate a technical overlay based on the historical financial data, the at least one technical overlay representing one or more financial data technical indicators applied to the historical financial data;
incorporate the technical overlay on the graphical display;
receive, via an input device, a user input of estimated financial data estimating financial data values over a second time interval;
update the at least one technical overlay based on the estimated financial data, including the technical overlay within the second time interval;
update the graphical display including the estimated financial data and the updated technical overlay; and
provide the updated graphical display with the updated technical overlay to a display device.

12. The system of claim 11, the processing device, in response to further executable instructions, further operative to:
electronically calculate the technical indicators on the estimated financial data based at least in part on the historical financial data.

13. The system of claim 11, the processing device, in response to further executable instructions, further operative to:
receive a second user input of second estimated financial data, the second estimated financial data being based, at least on, the estimated financial data.

14. The system of claim 11, the processing device, in response to further executable instructions, further operative to:
adjust the estimated financial data in response to the user input device; and
update the graphical display including the updated technical overlay.

15. The system of claim 14, wherein the dynamically adjusting the estimated financial data includes the processing device, in response to further executable instructions, further operative to:
establish a data point on the graphical display within the second time interval; and
adjust the estimated financial data beyond the data point.

16. The system of claim 11, wherein the user input of estimated financial data includes estimating at least one of: an increase in value; a decrease in value; and no change in value.

17. The system of claim 11, wherein the graphical display includes a display of the first time interval and the second time interval along an x-axis of the graphical display and the financial values and the estimated financial data along a y-axis of the graphical display.

18. The system of claim 11, the processing device, in response to further executable instructions, further operative to:
receive a periodicity input selection from the user indicating a periodicity of the historical financial data in the first time interval; and
calculate the estimated financial data based on the periodicity input selection.

19. The system of claim 18, the processing device, in response to further executable instructions, further operative to:
receive a second periodicity input selection for the user adjusting the periodicity of the historical financial data; and
update the estimated financial data values in the second time interval to be consistent with the second periodicity input.

20. Computer readable medium having executable code stored thereon that when executed by a processing device provides for a method of visual analysis of graphical representations of financial data, comprising:
executable code electronically generating a graphical display for a plurality of historical financial data, including the graphical display of values of the financial data over a first time interval;
executable code electronically generating a technical overlay based on the historical financial data, the at least one technical overlay representing one or more financial data technical indicators applied to the historical financial data;
executable code incorporating the technical overlay on the graphical display;
executable code receiving, via an input device, a user input of estimated financial data estimating financial data values over a second time interval;
executable code updating the at least one technical overlay based on the estimated financial data, including the technical overlay within the second time interval;
updating the graphical display including the estimated financial data and the updated technical overlay; and
executable code providing the updated graphical display with the updated technical overlay to a display device.
